(19) United States
(12) Patent Application Publication
(10) Pub. No.: US 2009/0106092 A1
(43) Pub. Date: Apr. 23, 2009

(54) Electronic voting system and method of voting

(75) Inventor: Dennis Edward Bowers, Middletown, DE (US)

Correspondence Address: Marvin J. Powell, Esquire, 621 Millers Hill, Kennett Square, PA, 19348-2431, US

(73) Assignee: Election Technology Services, LLC.

(21) Appl. No.: 12/287,210

(22) Filed: Oct. 7, 2008

Related U.S. Application Data
(60) Provisional application No. 60/998,156, filed on Oct. 9, 2007.

(51) Int. Cl. G07C 13/00; G06F 19/00

(52) U.S. Cl. 705/12

(57) ABSTRACT

The present invention relates to an electronic voting system. Further, the electronic voting system includes methods and processes for voter registration, voter determination and eligibility, candidate information, on-line ballot generation, real-time voting, real-time voting tabulation, and voter demographics.

The electronic voting system and method for electronic voting provides an integrated core election system (ICES). The ICES has a multiprocessor/mainframe/server based core software system that allows for real-time management of an election process across multiple localities at the local, state and national level.

This application claims priority from provisional application Ser. No. 60/998,156, filed Oct. 9, 2007, the entire disclosure of which are hereby incorporated herein by this reference.

### FIELD OF THE INVENTION

The present invention relates to an electronic voting system. Further, the electronic voting system includes methods and processes for voter registration, voter determination and eligibility, candidate information, on-line ballot generation, real-time voting, real-time voting tabulation, and voter demographics.

Voting systems generally used around the world generally include the need for pre-registration of the voter, paper ballots, mechanical machines, punch cards, optical scanning systems and direct recording voting equipment. The last few elections have shown these voting systems have been confusing, unreliable, and controversial, as exemplified by the controversy surrounding the 2000 U.S. presidential election in Florida, generating increased efforts to develop easier to use and more reliable voting systems.

Inaccurate information of eligible voters, paper ballots and/or punch cards being physically damaged or altered, and the time that a ballot is counted are concerns that have become prominent over the last several years and the time it takes to obtain results in the election process has increased rather than decreased.

When inaccurate information of eligible voters is encountered, or when the need to check on voter eligibility is required, it takes time for the election officials and voter to sort out the discrepancies and can cause eligible voters to not be able to vote.

Paper ballots and/or punch cards can be physically damaged or altered between the time voter makes their selections and the time the ballot is counted. Additionally, paper ballots must be custom printed for each precinct for each election making sure there are enough for each voter. Since the ballots are specific to a particular election the cost for printing the ballots can be significant.

Mechanical voting machines include mechanical switches and/or levers which are actuated by a voter to increment one of a plurality of mechanical counters. At the end of an election, the counters for each of the machines at each polling place are tallied and the results are reported to a jurisdictional headquarters. While these machines solve some of the problems associated with paper ballots and/or punch cards, the machines are fairly expensive and have many mechanical parts which require routine maintenance repair. In addition, these machines are heavy and cumbersome to move and set-up for each election. These machines also require manual tallying of the counters at the precincts and the manual reporting of the results to the jurisdictional headquarters.

In both the paper ballot and mechanical machine methods of voting, problems with illegible ballots, votes inadvertently cast for unintended candidates, excessive costs, and the ease with which the election results may be altered by tampering can be substantial. Additionally, inaccurate voter information and voter ineligibility is harder to detect and can be quite time consuming for election officials.

In recent years there has been increased efforts to develop electronic voting systems, but are currently used on a limited basis since most of these systems only perform certain functions of the voting process. Some of these systems for example, include a form of transportable memory, which is used to transport data between the jurisdictional headquarters and the precinct. Other electronic based systems include video displays which present the required ballot information to a voter. Such systems require the voter to scroll through the available options to make their selection. This may be confusing to some voters who may become lost and frustrated in the hierarchy of screen formats, so as not to complete their ballot or do so erroneously. Other electronic based systems can include voting tablets with printed ballot overlays laid on top of the voting tablet. In this case the voter actuates switches from a matrix of switches to make their selections. Again, this process may be difficult or confusing for a voter to understand.

Another problem with electronic-based systems is the inability to deal with differing ballot styles even within a precinct wherein certain voters may be eligible to vote on certain races and other voters eligible to vote on other races. Most electronic based systems must be manually controlled to provide the proper ballot styles to each voter or the proper combinations selected from among many to provide the correct eligibility for the voter. This places undue burden on the operators administering the election and presents significant opportunity for error.

Other proposed electronic-based systems include machine readable cards that are given to each voter. The voter must be given the appropriate card for that voter, and then properly place the card in a voting terminal before they can vote. This system can be time consuming and present the possibility of errors and confusion as well.

There has also been proposed electronic systems that use various processes for voter registration and authentication; ballot generation; and vote collection and tabulations. However, these systems don't address certain election issues, such as, for example, demographics and how demographics impact an election.

Accordingly, there is a need for an improved computerized electronic voting system that link the various phases of the election process including: voter registration, ballot generation, on-line ballot presentation, on-line voting, vote collection, real-time vote tabulation, and integrated election results tracking with vote-to-demographic profiles, while at the same time makes voting accessible, easy to do, inexpensive, and secure.

### BRIEF SUMMARY OF THE INVENTION

The present invention relates to a system and method for electronic voting using an integrated core election system (ICES). The integrated core election system (ICES) allows management of an election process across multiple localities. The system comprises a plurality of voter workstations that are linked to a host processor accessed by the voter workstations for processing voter balloting information and maintaining voter elections. The host processor includes a voter registration database for determining voter eligibility, authentication, and demographic information. Additionally, there is a ballot generation database, wherein once voter authentication is verified, is directed to an appropriate precinct through a localities server linkage where an appropriate ballot is generated and presented to the voter. The voter makes their selection(s) and prior to being sent to a vote collection database requires confirmation of voting choices by the voter. After the voter confirms their choices the votes are sent to a vote collection database which is a central collection point that includes a process wherein the voter is blocked from re-voting and wherein real-time voting i.e., as fast as technology allows, is realized so that local, state, and national results can be determined simultaneously and tracked. The collected votes are then sent to a tabulation database for detailed queries of real-time election result totals. The result totals can be presented through web and internet interface wherein the result totals can be captured at a detailed demographic level.

The present invention also relates to a method for electronic voting using an integrated core election system (ICES) having remote workstations in a network. The method establishes an eligible voter and provides that voter with an appropriate election ballot that includes candidates and referendums for which the eligible voter can vote. After the eligible voter casts their vote(s) the vote is sent to a central collection point or system. From the central collection system, the votes are transferred to a host processor for tabulating and compiling voter election results.

### BRIEF DESCRIPTION OF THE DRAWINGS

The accompanying drawings, which are included to provide further understanding of the invention and are incorporated in and constitute a part of this specification, illustrate. These and other features, aspects, and advantages of the present invention will become better understood with regard to the following description, appended claims, and accompanying drawings where:

FIG. 1—ICES—Ballot Setup/Presentation/Voting Process, depicts an overview of an integrated core election system (ICES) as consistent with the present invention.

FIG. 2—ICES—Voter Registration Process, depicts a flow chart of a voter registration and validation process as consistent with the present invention.

FIG. 3—ICES—Election Tracking Process, depicts a flow chart of an election tracking process as consistent with the present invention.

### DETAILED DESCRIPTION OF THE INVENTION

An electronic voting system and method for electronic voting is provided for using a central hosting facility, also referred to as an integrated core election system (ICES). The ICES comprises a multiprocessor/mainframe/server based core software system that allows for management of an election process across multiple localities. This is accomplished by integrating high-volume common tasks associated with an overall process in an efficient and cost effective manner. Additionally, the host or core processor can provide backend processing for different front-end touch-point configurations

The ICES, includes an ICES Mainframe Sysplex that performs and integrates components of an election process including Ballot Set-up and Presentation, Voter Registration and Validation, On-line Voting, Real-Time Vote Counting, and Integrated Election Results Tracking. The vote totals being captured at a detailed demographic level.

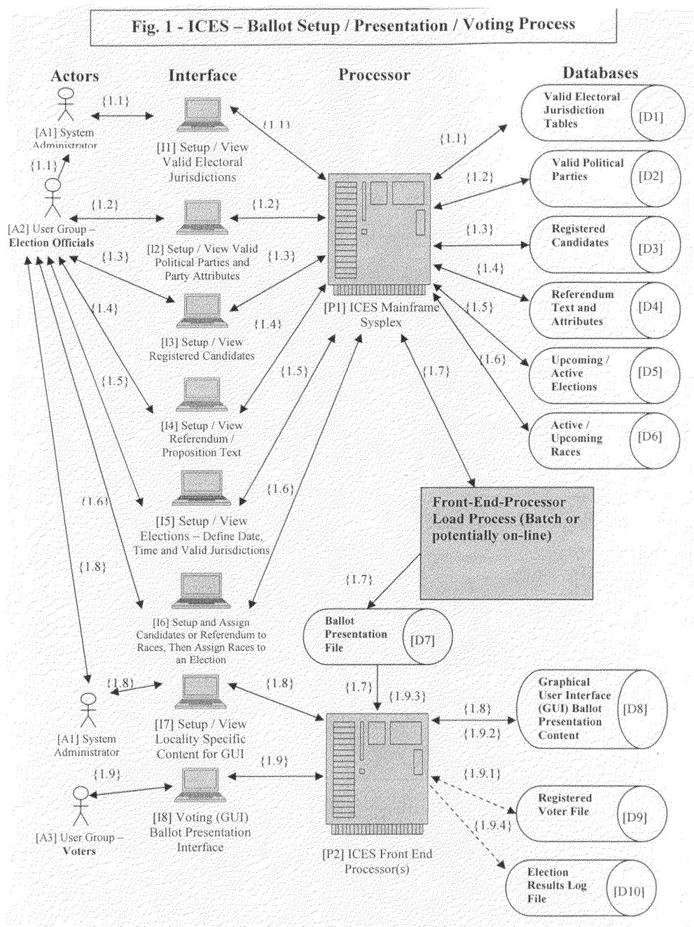

FIG. 1 shows an embodiment of an ICES wherein, for any given election, the voting system is set-up by a System Administrator (A1) or Election Official (A2), prior to a particular election taking place, through an interface or multiple interfaces with an ICES Mainframe Sysplex (P1). The interface can be, for example, a CICS (customer information control system) screen, XML (extensible markup language) on-line screen, and/or SOAP (simple object access protocol) interface. The System Administrator (A1) or Election Official (A2) can be one or more persons. The System Administrator (A1) and/or Election Official (A2) provides and enters information pertaining to an Electoral Jurisdiction (I1), for example, country, state or province, and/or locality, in which the ICES Mainframe (P1) is being used. As used herein, a jurisdiction is a governmental entity and/or territory in which an election is to occur and/or a territory where voters are placed into groups, for example, precincts. Additionally, jurisdictions can include the country where an election is to take place, states or territories within the country, and in the case of the United States, Congressional districts, State Senate and Representative districts, counties and/or burrows. Cities, towns, districts, and other localities can also be included within a jurisdiction. Each jurisdiction is assigned, for example, but not limited to, a name, description, and a unique identifier. The System Administrator (A1) or Election Official (A2) enters the jurisdiction information into the ICES Mainframe (P1), using an Electoral Jurisdiction Interface (I1). This information is stored on a valid Electoral Jurisdiction File (D1) and candidates and races can be assigned to an appropriate jurisdiction.

Once an electoral jurisdiction is defined, the Election Official (A2) determines the political parties that are valid for the country, state, province, and/or locality using the ICES Mainframe (P2). The Election Official (A2) assigns each political party, a name, description, and/or a unique identifier. The Election Official (A2) provides the party information to the ICES Mainframe (P1) through a Political Party and Party Attributes Interface (I2) and the information stored on a Political Party File (D2). This enables individual candidates and primary races to be assigned to political parties defined in the Political Party File (D2).

Once information on the political parties is defined in the Political Party File (D2), the Election Official (A2) can enter information through a Registered Candidate Interface (I3) and a Registered Candidates File (D3) is created and the candidate assigned to the appropriate political party. This information can include, for example, a candidate name, party affiliation, unique identifier and/or any desired attributes of the candidate, allowing a candidate to be assigned to the appropriate race they are running in.

After a candidate has been defined and assigned to a particular race, the Election Official (A2) can enter information onto the ICES Mainframe (P1) through a Referendum and Proposition Text and Attributes Interface (I4). This information includes referendums, propositions, and/or questions being considered in the current election. Additionally, the information entered can include, for example, a short name, referendum text, narrative description, sponsoring locality, valid responses, and/or other descriptive information. This information is stored on a Referendum and Proposition File (D4). This allows the referendums, propositions, and/or questions to be assigned to a particular race and jurisdiction.

The Election Official (A2) then enters information pertaining to a particular election onto the ICES Mainframe (P1) using an Active Election Interface (I5). The election information can include, for example, the name and/or description of the particular election being run, for example, primary election, mid term election, and/or presidential election. Additionally, other election information can include election starting and ending dates and times, localities included in the election, and/or other desired descriptive information. This information is entered into the ICES Mainframe (P1) and stored on an Active Election File (D5). What is meant by an election is a grouping of one or more races scheduled to run within a predefined timeframe.

Once information on active elections is entered onto the ICES Mainframe (P1), an Election Official (A2) enters information on current election races and an Active Race File (D6) is established. An election race is defined by information entered onto the ICES Mainframe (P1) through a Candidate Assignment Interface (I6) by an Election Official (A2). Information includes, for example, race name, race description, type of race, assigned candidates, localities where the race is being run, registered candidates, referendums, propositions, questions, the election in which the race is included, and/or other descriptive information. This information allows a race and candidate to be assigned to a particular election.

After the Electoral Jurisdictions (I1), Political Party and Party Attributes (I2), Registered Candidates (I3), Referendum and Proposition Text and Attributes (I4), Election (I5), and Candidate Assignment (I6) information is entered onto the ICES Mainframe (P1) and the appropriate files (D1, D2, D3, D4, D5, and D6) are established, the information in the files is consolidated by the ICES Mainframe (P1) in a pre-election batch or on-line process and sent to a Front-End Processor (FEP) (P2) where a flat file or files are created to support ballot presentation to voters. The FEP (P2) configures information from a Ballot Presentation File (D7) and GUI Ballot Presentation File (D8) for presentation to a Voter (A3) on a Ballot Presentation Interface (I8). The Ballot Presentation File (D7) is keyed and sorted using information such as, for example, election, country or highest level locality, state or province, and/or precinct or lowest level locality. In elections such as primary elections, the Ballot Presentation File (D7) can also be keyed and sorted by political party and for each precinct. Additionally, the Ballot Presentation File (D7) can contain information such as, for example, valid jurisdictions, races, candidates, party affiliation of each candidate, referendums, propositions, and/or any other desired information, for presentation to the Voter (A3).

Additionally, a database containing Graphical Content and/or Information (D8) can be created and uploaded to the Front-End Processor (P2) for ballot presentation to the voters. The System Administrator (A1) can enter information on Locality Specific Content for GUI Ballot Presentation (I7) through an interface with the FEP (P2) creating a GUI Ballot Presentation Content File (D8). The information can be made specific to any locality by the Election Official (A2). The Front-end Processor (P2) combines the graphical content with the consolidated information in the Ballot Presentation File (D7) and the appropriate ballot presented to the Voter (A3).

Once voter eligibility and authentication is confirmed, as described below, the ICES is ready for voter access and voting can begin. Voter access can be accomplished using various methods and security protocols based on local user requirements and established authentication technologies and procedures. The FEP (P2) retrieves the appropriate ballot information using voter information retrieved from the Registered Voter File (D9), Graphical Content and Information File (D8), and the Ballot Presentation File (D7) and presents an appropriate ballot to the Voter (A3).

After the Voter (A3) enters and confirms their choices, the votes are recorded in an Election Result Log File (D10) that captures the voting results and demographic information of the Voter (A3) without specifically identifying the particular voter. Simultaneously, a record will be added to the Registered Voter File (D9) indicating whether a particular voter has voted or not and prevents that voter from voting a second time. The information in the Election Result Log File (D10) is used to determine the official results of the election and used for real-time election results tracking as defined below.

Optionally, the Election Result Log File (D10) can also store an encrypted version of each voter's ID that could then be used to support any disputes involving the vote or election process. For example, when an individual is denied voting access because the ICES Election System shows that they had already voted and the voter claims otherwise. When a vote is disputed, the person is matched to their voting record and all election result totals that were counted as a result of their vote will be decremented. If it is confirmed that the vote should be counted, it will be recast and the appropriate totals incremented.

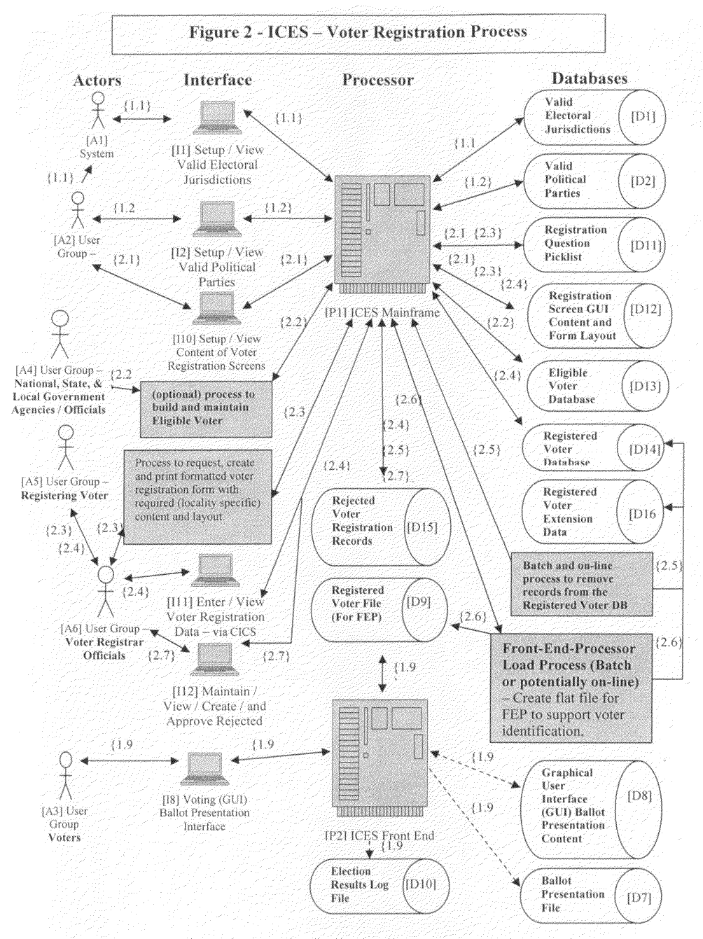

FIG. 2, shows an embodiment of a voter registration process using an ICES Election System consistent with the present invention. An Election Official (A2) or System Administrator (A1), under direction of the Election Official (A2), sets-up the Electoral Jurisdictions File (D1) and Political Party File (D2) as described above. Each jurisdiction is assigned, for example, a name, description, unique identifier, and/or any other necessary or desired information. Political parties are defined for a particular election or race and the information onto the ICES Mainframe (P1) through an interface, i.e. CICS screen, XML, and/or SOAP.

An Election Official (A2) enters questions through a Voter Registration and Form Interface (I10) thus creating a Registration Question Picklist File (D11). These questions are presented to a Registering Voter (A5) via a Voter Registration Interface (I11) upon registering to vote. The questions can either be required or optional for the Registering Voter (A5) to answer, each question will be noted as being required or optional to answer. The Election Official (A2) also enters other information and rules through the Voter Registration and Form Interface (I10) necessary in defining the registering voter, which information is also stored in the Registration Question Picklist File (D11). Locality specific graphical content for registration form presentation will be determined by the ICES Mainframe Sysplex (P1) and driven by configuration files and stored in a Registration Screen Content and Form Layout Rules File (D12).

Optionally, a file containing Eligible Voters (D13) can be created and maintained. This database would contain names and information of people nationwide that are eligible and/or ineligible to register to vote. Eligibility or ineligibility would be defined by a User Group (A4), such as a Federal, State, or Local Government Agency or Official and/or a Law Enforcement Entity dependent upon the particular election being run. The User Group (A4) would perform their own internal analysis using, for example, Social Security records, death records, criminal records, and/or other identifying records to create and update these files. The files are transmitted to the ICES Mainframe (P1) and updated periodically and prior to any elections

The ICES Mainframe (P1) evaluates each Registering Voter (A5) against internal files to determine that a person is either eligible or ineligible to vote. If the Registering Voter (A5) is deemed ineligible, the registration is rejected, and a record for the registration attempt is sent to a Rejected Voter Registration File (D15). Additionally, a registration attempt that is rejected may be sent to a queue that is manually worked by one or more of the User Groups (A4) noted above.

The Registering Voter (A5) may also request a registration form from a Voter Registrar (A6). The voter registrar (A6) can either print the requested form or have pre-printed forms available with predefined questions and rules found in the Registration Question Picklist File (D11) and Registration Screen Content and Form Layout Rules File (D12) that are appropriate for the locality and election in question.

The Registering Voter (A5) or voter registrar (A6) enters registration data via an on-line Voter Registration Interface (I11) and the questions and rules content taken from the Registration Question Picklist File (D11) and Registration Screen Content and Form Layout Rules File (D12). The registration data will then be evaluated against the Eligible Voter File (D13). Successful registrations will be loaded to a Registered Voter Database (D14) on the ICES Mainframe (P1) along with all demographic and other information captured from the Registering Voter's (A5) answers to the registration questions.

The Registered Voter Database (D14) contains records of eligible voters and assigns unique voter identification for each Voter (A3). The unique voter identification serves as a key for all internal tables or files that ties the registered voter to a country, state, province, locality, precinct, address, and/or demographic profile including, for example, the voter's name, address, and any other desired demographic information.

In an embodiment, the Registered Voter Database (D14) can include voter information such as, for example, the names of registered voters and is accessible through an interface, by a registered voter or person desiring to register to vote as well as a System Administrator (A1) or Election Official (A2). The Registered Voter Database (D14) could be accessed from any authorized location and be subject to the Voter's (A3) local or state laws governing the voting process. The System Administrator (A1) or Election Official (A2) can access the Registered Voter Database (D14) through an interface at a local election office. System Administrators (A1) and Election Officials (A2) would have process capabilities including managing the registration process for a particular jurisdiction.

Optionally, a locality or jurisdiction can also capture additional information on their voters during or after registration. This information could be stored on an optional Registered Voter Extension File (D16). Additionally, a locality can allow eligible voters to register while an election is in progress.

Based on the voter information stored in the Registered Voter Database (D14), the voter's precinct can be determined based, for example, the unique voter identification assigned to the voter, and/or through a ZIP code, street address or combination thereof.

Once the precinct of a Voter (A3) is determined, the electorates in which an eligible voter can participate can be derived. Additionally, a voter record can be created based on the information contained in the Registered Voter Database (D14). For any particular voter and depending on the rule set for the state/locality/precinct of the eligible voter, a card and any other necessary information and correspondence can be issued and mailed to the Voter (A3).

If a Registered Voter (A5) is deemed ineligible, a batch process can be executed to remove records from the Registered Voter Database (D14) and the Registered Voter Extension File (D16) for ineligible and/or deceased voters. A separate on-line process, which is part of the on-line voter registration process, can be executed to remove records from the Registered Voter Database (D14) for relocating voters that is in response to a registration request for an existing voter.

A pre-election batch process can be run to upload voter registration data from the Registered Voter Database (D14) and Registered Voter Extension File (D16) to the Registered Voter File (D9) on the FEP (P2). Additionally, an on-line process can be used to load registration information real-time to both the Registered Voter Database (D14) and Registered Voter Extension File (D16). This on-line process can be used to resolve eligibility issues that arise during an election and may be used to support registration during an election, based on user requirements.

When a registration request is rejected, the request can be assigned to a Manual Work Queue Interface (I12) for viewing, maintaining, creating, and/or approving rejected voter registration records by the Voter Registrar (A6). Additionally, the Registering Voter (A5) can make a determination whether a reject reason goes to the Manual Work Queue Interface (I12) or automatically notifies the Registering Voter (A5) without going to the Manual Work Queue Interface (I12). Optionally, a Registering Voter (A5) can request a hard copy, for example a letter, be sent to them at Registering Voter's (A5) address of record.

Information on rejected voters can be viewed through access to the records stored in the Rejected Voter Registration File (D15) using the Manual Work Queue Interface (I12), which is also connected with the ICES Mainframe (P1).

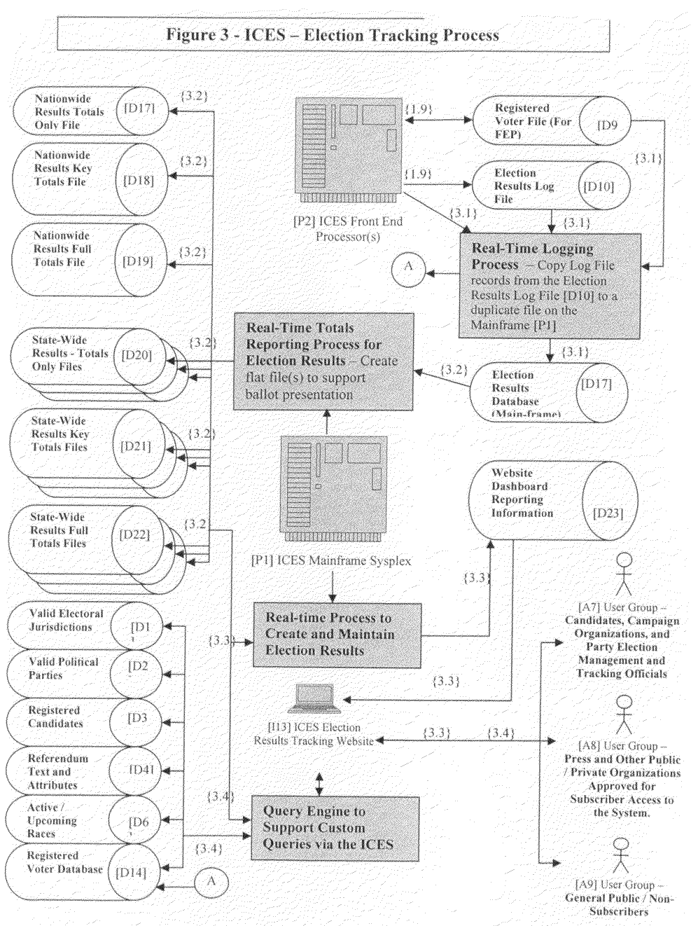

FIG. 3, shows an embodiment of a real-time election results tracking process consistent with the present invention. Based on specific parameters, an Election Official (A2) would monitor and control the set-up and/or modification of a Ballot Presentation File (D7) consisting of jurisdictional information as described above.

Optionally, the Ballot Presentation File (D7) could contain elements that link the candidate to any races that they are registered in.

In another embodiment, the Election Official (A2) could monitor and control the set-up and/or modification of any referendum and/or propositions of the Referendum Text and Attributes File (D4). Referendum information could include, for example, referendum identification, referendum name, referendum type, descriptive text and/or any other information describing the referendum. This information could then be incorporated into the Ballot Presentation File (D7).

Optionally, the Ballot Presentation File (D7) could contain links to any other races where the referendum is pertinent.

Additionally, the Election Official (A2) could optionally create unofficial polling questions on a polling database that ultimately displays on every ballot for the jurisdiction assigned to the polling question in the database.

Deleted.

Information contained in the Ballot Presentation Files (D7) is placed on the Front-end Processor (P2) and can include the name and other defining characteristics of a particular race such as, for example, presidential primary, congressional run-off, mayoral, referendum, and the like. The information on candidates and referendums would be obtained from the Register Candidate File (D3) and Referendum File (D4) that were set-up prior to the Ballot Presentation File (D7) and which were assigned to a particular race.

Identification of registered candidates or referendums would automatically be downloaded into the Ballot Presentation File (D7) for each eligible voter. Additionally, the Ballot Presentation File (D7) can be assigned to any jurisdiction or locality and automatically linked to all appropriate precincts.

Optionally, the ICES could define localities, precincts, and/or street numbers/ZIP code combinations within a higher level jurisdiction so as to be excluded from a race.

Prior to an election, the information needed for a scheduled election is retrieved from the ICES Mainframe (P1) and placed on the front-end processor (FEP) (P2) in a data configuration optimized for efficiency, and the information is made available through the Voter Registration Interface (I11).

Identifying information of the registered voter is entered into a voting terminal or interface. This information can be entered by the Registering Voter (A5), an on-site Voter Registrar (A6), and/or a combination of the two. If the information is entered by a combination of the Registering Voter (A5) and Voter Registrar (A6), the Registering Voter (A5) could enter the information on the Voter Registration Interface (I11) and the Voter Registrar (A6) could enter information on a second on-site administrative interface.

The Voter Registration Interface (I11) communicates with the ICES Mainframe (P1) and obtains the Registered Voter File (D9) identifying information from the Registered Voter Database (D14). This can be done, for example, via a middleware gateway. Additionally, the FEP (P2) retrieves information from the Registered Voter File (D9) and transfers an appropriate ballot to the Ballot Presentation Interface (I8) based on the registering voter's identifying information. The ballot would contain all appropriate races, candidates, referendums, and poll questions specific to the Eligible Voter (A3). This ballot retrieval can also be accomplished by a front-end configuration of web servers.

The ballot is presented to the Eligible Voter (A3) through the Ballot Presentation Interface (I8) in a user friendly graphical format approved by the locality. The Eligible Voter (A3) completes the ballot and upon confirmation indicating completion, the ballot is sent back to the FEP (P2). At this time the results of the vote are recorded in an Election Results Log File (D10). The Election Results Log File (D10) captures the voting results and demographic information available on the voter without specifically identifying the voter.

A voter's identifying information and the cast votes will only be associated long enough for a real-time process to transfer the information to the ICES Mainframe (P1) and tie the voting information that is on the voting record to a voter's general demographic profile. Once the voting record is real-time linked to the ICES Mainframe (P1) the information that ties a vote to a specific voter will be deleted and not stored on any of the result log files. The information sent to the ICES Mainframe (P1) that ties a vote to a voter will be stored in memory to identify a general demographic profile. However, the information that ties a vote to a specific voter will not be stored on any database or file. Therefore, at no time during the election process will an individual, i.e. System Administrator (A1), Election Official (A2), Voter Registrar (A6), be able to tell who a specific voter voted for.

After voting is completed as described above, the vote is sent to vote collection database or Election Results Log File (D10). The Election Results Log File (D10) captures the voting results and demographic profile available on the Eligible Voter (A3). The demographic information will exclude information for specifically identifying the particular voter, but can contain, for example, a general profile and who “that profile” voted for in each race identified on their ballot, thus allowing the ICES Mainframe (P1) to support a detailed real-time reporting of election results at the race and demographic level. Additionally, a demographic profile could include the percentage of ethnic groups or the percentage of people living in a particular county that have voted, city, ZIP code, and/or a particular subdivision who have voted for a particular candidate.

During an election, a continuous, real-time logging process is enabled while the election is in progress. All of the information from the Election Results Log File (D10) captured on the FEP (P2) is transferred to an Election Results Database (D17) located on the ICES Mainframe Sysplex (P1). Additionally, this process updates the Registered Voter Database (D14) on the ICES Mainframe (P1) and flags any individual that had already voted and that tries to access the system again. The information located in the Election Results Database (D17) of the ICES Mainframe (P1) will be used to create various additional files such as, for example, Nationwide Results Totals Only File (D18), Nationwide Results Key Totals File (D19), Nationwide Results Full Totals File (D20), Statewide Results Totals Only File (D21), Statewide Results Key Totals File (D22), Statewide Results Full Totals File (D23), that are used to query election results data that is stored in the files.

As stated above, information stored in the Election Results Database (D17) is used to create the various tables or files (D18 through D23), which are used to support real-time preliminary or dashboard election results and/or standard or custom queries submitted by an authorized subscriber. The specific data configuration of tables or files (D18 through D23) may vary based on the optimal structure needed to support user reporting requirements. This can be used to determine a structure that can balance optimal performance of election results tracking, the totals reporting process, the preliminary or dashboard reporting process, and the Query engine, which will subsequently described.

Tables or files (D18 through D23) can be configured when the ICES Election System is deployed at the national level in the United States. The Nationwide Results Totals Only File (D18) and Statewide Results Totals Only File (D21), would have the nation and each state in a performance friendly table listing only, for example, the total votes for each candidate in a race, the ID and name of the race, and the party affiliation of each candidate. The Nationwide Results Key Totals File (D19) and Statewide Results Key Totals File (D22) would list, for example totals by race and candidate broken down by a certain number of users selected critical voter demographic elements. The Nationwide Results Full Totals File (D20) and Statewide Results Full Totals File (23) would list, for example, totals by race and candidate broken down by all available voter demographic elements. The basic structure of all of the tables could be one column for each descriptive element that will be tracked along with the vote. This could include information such as, for example, voter demographic data as well as data about the particular race, the selected candidate, and the vote, such as time and location of the vote. The tables could also contain data for each combination of elements for which individual voting totals could be tracked. If the ICES Election System is deployed at a state or local level only, a lesser number of tables would be required.

Real-time election results dashboard or preliminary reporting is a continuous process that uses data from the election results tracking tables or files (D18) through (D23), to create a Dashboard Reporting File (D24) that will be displayed by the ICES Election Results Tracking Web Interface (I13) to display up-to-the-minute election results broken down by critical demographic elements

Certain election results can be accessed via a web interface by various user groups. This is a user initiated process that could be accessed by Authorized Subscribers (A7), Approved Authorized Subscribers (A8) and Non-Subscribers (A9). Authorized Subscribers (A7) would include, for example, candidates and their campaign organizers, political party election management and/or tracking officials. Authorized Subscribers (A7) would be able to select and run a set of standard queries that would use data from any of the Result Tracking Tables or files (D18), (D19), (D20), (D21), (D22) and/or (D23). Approved Authorized Subscribers (A8), would be authorized with approval from the System Administrator (A1), and would include, for example, press organizations and other public and/or private organizations approved for subscriber access. Approved Authorized Subscribers (A8) could build and run custom queries with access to any of the tracking results tables and/or other tables or files with descriptive information such as, for example, jurisdictions (D1), political parties (D2), candidates (D3), referendums (D4), active elections (D5), active races (D6), and/or information from the Registered Voter Database (D14). These queries could be used to determine and gather a demographic breakdown on, for example, who and who has not voted in the election.

Optionally, pre-election queries could be run comparing the Eligible Voter File (D13) to the Registered Voter Database (D14) to identify eligible voters who have not yet registered to vote.

Once the timeframe for voting in a particular election is over, the ICES Mainframe Sysplex (P1) will no longer accept votes and the voting files will be closed out. A batch process would be executed ensuring every vote captured on the Election Results Log File (D10) is copied over to the ICES Mainframe (P1). Additionally, the batch process ensures that every voter that was flagged to have already voted on the Registered Voter File (D9) on the FEP (P2) has been flagged on the Registered Voter Database (D14) on the ICES Mainframe (P1).

The batch process also ensures that voting totals on the Results Tracking Totals Only Files (D18) and (D21) match the total votes for each race, candidate, and/or referendum as captured on the Election Results Log File (D10). Once this process is complete, the results contained on the Results Tracking Totals Only Files (D18) and (D21) will be used to declare the official winner of each race and the official winner indicated on the file.

If a winner cannot be declared due to vote disputes, the disputes will be examined and when resolved, the votes recast and the appropriate votes incremented to the final results thus determining the winner.

All election specific files on the ICES Mainframe (P1) and the FEP (P2) will be archived and placed in long-term storage. This would include information or files contained in, for example, the FEP files minus GUI Ballot Presentation Content (D8). Long-term storage files can also include the files located in the Election Results Tracking Files (D18) through (D23), and the Election Results Database (D17).

### EXAMPLE

The following non-limiting example is merely illustrative of some embodiments of the present invention and is not to be construed as limiting the invention. The following Illustrates one way for using the ICES System in a state election held in the United States.

During the initial set-up of the ICES System, an election official enters defining data for each jurisdiction/locality that is valid for the state, such as, the state, county, city, township, federal congressional district, state senate and/or representative district, and any other jurisdiction or territory where the election is to take place, into an Electoral Jurisdictions Database or Table. Additionally, an election official enters defining data for each political party that is valid for each state is entered into a Political Party Database or Table.

The election official then sets-up voter registration in which questions and instructions or flags, that indicate whether the questions are required or optional to answer, are entered into a Registration Question Picklist Table. Additionally, other defining data deemed necessary to capture about the voter is stored in this table.

Additionally, the election official, or a representative of the election official, enters locality specific graphical information into the ICES System and this information is used to produce a registration form for that particular locality.

A person desiring to vote in an upcoming election reports to the proper location and obtains a registration form, containing the questions and information previously entered into the ICES System by the election official or representative for that locality, from a voter registrar. After the registering voter answers the required questions, the voter registrar enters the registration data, via on-line interface, into the ICES System. If the registering voter is deemed a valid voter the information obtained from the voter registration form, including all demographic information, is loaded and stored in a Registered Voter Database.

As an election approached and candidates register to run for an office, the election official enters defining data for each candidate for each race in the overall election in a Registered Candidate Database or Table. Additionally, the election official enters text and other defining data for any referendums, propositions, etc. . . . that will be voted on within the defined jurisdiction in the upcoming election, into a Referendum Database or Table. Other information, such as, election date, starting and ending times etc. . . . is entered into an Upcoming/Active Election Database or Table.

Additionally, election officials can design the graphical content for ballot presentation to the voter including how the ballot visually appears. The front-end processor can marry graphical content with the official or textual content from the Register Candidate database or table, which is then presented to the voter.

Through an on-line interface, polling information, such as, the name of the polling place, associated locality, address, administrators and/or other descriptive polling information is entered into the ICES System. This information can also be entered during the initial set-up of the ICES system.

Each polling/voting place is equipped with one or more terminals used by the voters. Each terminal has a unique ID and encrypted password stored in the terminals internal ROM. The unique ID and password has been programmed into and is recognized by the ICES System that is associated with each particular polling/voting place. Upon activation of the terminal and with each vote, the unique ID and encrypted password is transmitted to the ICES FEP for validating the terminal is one for use in voting in the current election.

Prior to a particular election, a pre-election batch process runs on the ICES mainframe that reads the various databases or tables previously described in the example and a consolidated file of ballot information is created to be uploaded to the FEP for presentation to the voter. The created file is precinct specific and can list valid jurisdictions, races, candidates, party affiliations of each candidate, referendum and/or proposition information and other information necessary for the voter.

Additionally, a pre-election batch process is run to upload voter registration data from the Registration Database, to the Registration File on the FEP. This can include an on-line process for loading voter information real-time for voter registration before and/or during an election.

In addition to the terminals used by the voter, each polling/voting place has one or more administrative terminals for use by election and/or precinct administrative officials at each locality enabling polling/voting places to be located outside of any particular precinct. The administrative terminals enable the election/administrative official to log onto a Polling Place Administrator Work Page maintained in the ICES mainframe allowing the administrator to select their appropriate polling/voting place from the Work Page. Additionally, the administrator inputs each terminal ID that is being used at that polling/voting place into the ICES system.

Also, the election/administrative official activates the voter terminals and confirms the polling/voting place that a voter terminal has been assigned and can include information from the ICES system pertinent to the current election. Subsequent to the administrator confirming the necessary information, the terminal is assigned to a particular voter booth and a first ballot page is presented to the voter

Once a voter's identity is confirmed by the election or administrative official, the official enters the voter's personal information into an ICES Voter Identification screen. Names appear matching the entered information and the administrator confirms and selects the appropriate name, address, etc. that matches the current voter. If the current voter had previously voted, the ICES generates an error message that is sent to the administrator and the individual voter in question is prevented from continuing to vote.

If no error message is received by the administrator, the administrator assigns a specific terminal to the voter, relays this information to the ICES, and directs the voter to that terminal for voting. At the voter terminal, the first page of the ballot is presented to the voter wherein the voter the voter enters their votes after which the voter is prompted to confirm their selections. Once a voter confirms their selections, the voter submits the votes and their final selections are submitted to the ICES FEP. If the ICES has successfully processed the vote, a temporary screen displays to the voter that their vote has been successfully recorded. The voting terminal then resets and is ready for the next assigned voter.

Once a vote is submitted to the ICES FEP, a record is added to an Election Results Log File capturing the voting results. In addition to the votes being recorded, non-specific demographic information is captured in the Election Results Log File.

Subsequent to submitting a vote to the ICES FEP, a real-time logging process runs in which the vote captured in the Election Results Log File is written to an Election Results Database on the ICES mainframe. The real-time logging process also updates the Registered Voter Database/Table on the ICES mainframe indicating a particular voter has voted in the current election.

During the election a continuous process captures each voting record incrementing the appropriate totals tables, (i.e. State-Wide Totals, State-Wide Key Totals, Totals for each individual county, city, town etc.) based on the voter's demographic attributes and the candidates, referendums, and/or proposals that were voted for.

The ICES has a continuous process that uses the data from the election results tracking tables to create a file that is used by the results tracking web interface to display up to the minute election results broken down by desired demographic elements. These votes are included in all appropriate totals available via the web interface.

Users of the results tracking web interface can view up to the minute election results of any race broken down by demographic elements and view any desired voting result.

Authorized subscribers to the web interface can run queries that use data from any of the results tracking tables. With approval from election or administrative officials, the subscriber can build and run custom queries with access to any of the tracking tables and other ICES tables having descriptive information on jurisdiction, races, candidates, parties, etc. The subscriber can also query the Registered Voter Database for gathering demographic breakdowns that could include appropriate non-specific demographic totals of registered voters who have and have not voted in the current election.

When the polling/voting place is closed from voting, no more votes are accepted by the ICES system. A batch process is run by the ICES system ensuring every vote captured on the FEP Log File is transferred to the ICES mainframe. This includes ensuring every voter that had been flagged on the Registered Voter File on the FEP has also been flagged on the Registered Voter Database on the ICES mainframe.

The batch process also ensures voting totals on the Results Tracking Totals Only files match the total votes for each race, candidate, and/or referendum as captured on the Election Results Log File. After verification, the results contained on the Results Tracking Totals Only files are used to declare the official winner of each race.

Additionally, the voting terminals transmit information on the votes captured at each terminal to the FEP which reconciles any discrepancies between the individual terminal log and FEP log. When a record from the terminal is not found on the FEP log file, the FEP log file is updated. If records on the FEP log file (or any downstream file) cannot be reconciled against the voter terminal, the vote is expunged or placed in a dispute file for research by the appropriate election officials.

I claim:

1. An integrated core election system (ICES) allowing management of an election process across multiple localities comprising:
a plurality of voter workstations;
a host processor accessed;
a ballot generation database;
a vote collection database wherein the votes are sent to a central collection point including a process wherein the voter is blocked from re-voting and wherein real-time voting is realized so that local, state, and national results can be determined simultaneously and tracked; and
a tabulation database for detailed queries of real-time election result totals including presenting the results through web and internet interface wherein the result totals are captured at a detailed demographic level.

2. The host processor of claim 1 wherein the host processor is accessed by the voter workstations for processing voter balloting information and maintaining voter elections.

3. The host processor of claim 2 wherein the host processor includes a voter registration database for determining voter eligibility, authentication, and demographic information.

4. The ballot generation database of claim 1, wherein once voter authentication is verified, is directed to an appropriate precinct through a localities server linkage where an appropriate ballot is generated and presented to the voter.

5. The ballot generation database of claim 4, wherein the voter makes their selection(s) and prior to being sent to the multiprocessor requires confirmation of voting choices by the voter.

6. A method for allowing management of electronic voting using an integrated core election system (ICES) having a plurality of workstations comprising:
processing voter balloting information and maintaining voter elections;
determining voter, eligibility, authentication and demographic information;
providing the eligible voter with an appropriate election ballot including candidates and referendums for which the eligible voter can vote;
receiving voter selection data at a vote collection system wherein real-time voting is realized so that local, state, and national results can be determined simultaneously and tracked; and,
transferring the voter election data from the vote collection system to a tabulating data base for detailed queries of real time election results totals including detailed demographics.

7. The method of claim 6 wherein the processing of voter balloting information and maintaining voter elections is performed by a host processor accessed by the voter.

8. The method of claim 7 wherein the host processor includes a voter registration database for determining voter eligibility, authentication, and demographic information.

9. The method of claim 6 wherein providing the eligible voter with an appropriate election ballot including candidates and referendums for which the eligible voter can vote is provided by a ballot generating database.

10. The method of claim 9 wherein the voter makes their selection(s) and wherein the voter selection(s) is/are confirmed prior to being sent to the multiprocessor.

11. The method of claim 6 wherein voter selection data are sent to a central collection point which includes a process to block voter from re-voting and wherein real-time voting is realized so that local, state, and national results can be determined simultaneously and tracked.

12. The method of claim 6 wherein the tabulating data base for detailed queries of real-time election results totals includes presenting the results through web and internet interface and wherein the results are captured at a detailed demographic level.

13. The use of the integrated core election system (ICES) of claim 1 which allows management of an election process across multiple localities wherein real-time voting is realized so that local, state and national election results are determined simultaneously and tracked.

14. The use of the method of claim 6 for allowing management of electronic voting using an integrated core election system (ICES) having a plurality of workstations which allows management of an election process across multiple localities wherein real-time voting is realized so that local, state and national election results are determined simultaneously and tracked.
